(19) United States
(12) Patent Application Publication
(10) Pub. No.: US 2016/0178564 A1
(43) Pub. Date: Jun. 23, 2016

(54) Electrochemical half cell and method for production of a half cell

(71) Applicant: Endress + Hauser Condcta Gesellschaft für Mess-und Regeltechnik mbH + Co. KG, Gerlingen (DE)

(72) Inventors: Magdalena Losik, Dresden (DE); Thomas Wilhelm, Chemnitz (DE)

(21) Appl. No.: 14/970,794

(22) Filed: Dec. 16, 2015

(30) Foreign Application Priority Data
Dec. 22, 2014 (DE) 10 2014 119 444.6

(51) Int. Cl. G01N 27/406; G01N 27/401; G01N 27/416; G01N 27/31

(52) U.S. Cl. CPC G01N 27/406; G01N 27/31; G01N 27/401; G01N 27/416

(57) ABSTRACT

The invention relates to an electrochemical half cell comprising:
a housing,
a potential sensing element, which is at least partially arranged within the housing and is electrically conductively connected to an electrical terminal pad arranged outside the housing; and
an electrolyte that is solidified and arranged within the housing, wherein a plurality of gas bubbles which are in particular uniformly distributed within the volume occupied by the electrolyte, are trapped in the electrolyte.

The invention relates to an electrochemical half cell and a method for production of a half cell. Such half cells are used in different electrochemical measuring devices.

Electrochemical measuring devices are often used in the laboratory and process measurement technology in many fields such as chemistry, biochemistry, pharmacy, biotechnology, food technology, water management and environmental monitoring for the analysis of measuring media, in particular measuring fluids. Electrochemical measuring techniques allow detection of, e.g., activities of chemical substances, such as ions, and thus correlated measured variables in liquids. The substance whose concentration or activity is to be measured is also referred to as the analyte. Generic electrochemical measuring arrangements may be, e.g., potentiometric or amperometric sensors.

Potentiometric sensors typically comprise a measuring half cell and a reference half cell and a measurement circuit. In contact with the measuring medium, e.g. a measuring fluid, the measuring half cell forms a potential that is a function of the concentration or activity of the analyte in the measuring medium, while the reference half cell provides a stable, reference potential independent of the analyte concentration. The measurement circuit generates a measuring signal that represents the potential difference between the measuring half cell and the reference half cell. The measuring signal may be outputted from the measurement circuit to a higher-level unit, such as a measuring transducer, which is connected to the sensor and further processes the measuring signal.

The reference half cell of generic sensors comprises a reference element which is in contact with a reference electrolyte. The reference electrolyte is housed in a chamber formed in a housing of the reference electrode. The reference electrolyte must be in electrolytic contact with the measuring medium in order to perform a potentiometric measurement. This contact is established by a electrochemical junction, which may consist of, e.g., a through-hole that passes through the entire housing wall, a porous diaphragm, or a gap. The potential of the reference half cell is defined by the reference electrolyte and the reference element. If the reference electrode is configured, e.g, as a silver/silver chloride reference electrode, the reference electrolyte is an aqueous solution with high chloride concentration, usually a 3 molar potassium chloride solution, while the reference element is a silver wire coated with silver chloride. The reference element is electrically conductively connected to the above-mentioned measurement circuit. The reference electrolyte can be thickened by adding a thickening agent, in particular a polymer. By strong cross-linking of the added polymer, immobilization of the reference electrolyte is achieved, so that the electrolyte no longer flows and cannot escape the housing through the electrochemical junction.

The measuring half cell includes a potential-forming element, which may comprise, e.g., a redox electrode, an analyte-sensitive coating or an ion-selective membrane, depending on the nature of the potentiometric sensor. Examples of potential-forming elements with ion-selective membrane are ion-selective electrodes (ISE). An ion-selective electrode has a housing, which is enclosed by an ion-selective membrane acting as a potential-forming element and includes an inner electrolyte, as well as a is potential sensing element, which is in contact with the inner electrolyte. If the measuring medium is in contact with the potential-forming element, change in an activity or concentration of the analyte in the measuring medium causes a relative change in the equilibrium Galvani potential between the potential sensing element and the measuring medium and the measuring fluid in contact with the potential-forming element via the inner electrolyte. The potential sensing element is electrically conductively connected to the measurement circuit. A special case of such an ion-selective electrode is the known pH glass electrode, which has a chamber, which is enclosed by a pH-sensitive glass membrane and includes a buffer system for setting an inner electrolyte with a stable pH value and a potential sensing element immersed therein. Ion-selective electrodes are described in, e.g., “Working with ion-selective electrodes,” K. Cammann, H. Galster, Springer, 1996.

Amperometric measuring devices may include, e.g., a three-electrode circuit having a working electrode, a counter electrode and a non-current-carrying reference electrode. Such a measuring device may have, e.g., a control circuit, in particular a potentiostatic one which is adapted to preset a nominal voltage between the working electrode and the reference electrode, and to detect the current flowing between the working electrode and the counter electrode in the process. The non-current-carrying reference electrode, also referred to as the reference half cell here and below, can be configured in the same way as reference half cell of a potentiometric measuring arrangement, in particular as an electrode of the second type.

Such sensors are often exposed to temperature fluctuations during their application in process measurement technology for monitoring electrochemical measured variables, in particular the concentration or activity of an analyte or the pH in a measuring medium. For example, it may be necessary to regularly clean or sterilize the sensors at elevated temperatures in a variety of processes in the food or pharmaceutical industry. In order to prevent rupture of the sensors in temperature and/or pressure fluctuations, a gas volume must be provided within the housing for compensating for the thermal expansion of an inner or reference electrolyte present in a half cell. This volume is also referred to as compensation volume.

Usually, porous elastic solid bodies, e.g. closed-pore neoprene or silicone foams, are is used as compensators for changes in the volume of the sensor housing occupied by the inner or reference electrolyte. In rod-shaped sensors, e.g., single-rod measuring cells, these compensators are often arranged at a rear side of the housing, i.e. facing away from the sensitive element. If the electrolyte is thickened so much by adding a polymer that it becomes only less fluid or even completely immobilized, the thermal work of the electrolyte in such an arrangement may lead to fractures and internal tearing of the electrolyte. Another disadvantage in using porous elastic solid bodies as compensators is that the introduction of the solid body in the sensor housing is relatively time-consuming and difficult to automate. In addition, when introducing the compensators in the housing, there is a risk of contamination of the interior of the housing, in particular of the electrolyte or of adhesive bonding areas.

Therefore, the object of the invention is to provide an electrochemical half cell and a method to produce said half cell which avoids the disadvantages mentioned.

This object is achieved by an electrochemical half cell according to claim 1, a sensor according to claim 8 and a method to produce a half cell according to claim 9. Advantageous embodiments are listed in the subordinate claims.

The electrochemical half cell according to the invention comprises:

a housing,

a potential sensing element, which is at least partially arranged within the housing and is electrically conductively connected to an electrical terminal pad arranged outside the housing; and

an electrolyte that is solidified and arranged within the housing, wherein a plurality of gas bubbles, which are in particular uniformly distributed within the volume occupied by the electrolyte, are trapped in the electrolyte.

Instead of a compensation volume arranged outside the volume occupied by the electrolyte, e.g. a compensator formed by a porous solid body, a plurality of compensation volumes that are essentially uniformly distributed within the volume occupied by the electrolyte are thus provided. The uniform distribution of the compensation volumes avoids the occurrence of an internal tearing due to thermal work of the solidified and thus immobilized electrolyte. The introduction of gas bubbles can be carried out during solidification of the electrolyte in the production of the half cell so that the additional process steps required for the introduction of solid bodies as compensators are completely eliminated and the risk of contamination of the interior of the housing of the half cell is avoided or at least significantly reduced.

A solidified electrolyte refers to an electrolyte that is thickened by a polymer, wherein the degree of cross-linking of the polymer is so high that the electrolyte is no longer fluid, but is, in particular cut-resistant. Such immobilization can be achieved by, e.g., one or more of the following polymeric additives: Agar-agar, gelatin, cross-linked polyacrylates, cross-linked polyacrylamide, cross-linked polyvinyl alcohol or cross-linked co-polymer based on diallyl dimethyl ammonium chloride (DADMAC).

The potential sensing element can be in direct contact with the electrolyte, i.e. touch it, or directly contact a second electrolyte in a protective tube arranged within the housing, wherein the second electrolyte is again in electrolytic contact with the electrolyte, e.g. via an bypass. The second electrolyte may be in contact with the first electrolyte via a diaphragm, via which charge carriers, such as ions, can be exchanged.

The half cell may be a reference half cell or a measuring half cell of a potentiometric sensor. The half cell may also be a reference half cell of an amperometric sensor. The potential sensing element is used for electrical contacting of the half cell by a measurement circuit, which is or can be electrically conductively connected with the s potential sensing element via the terminal pad. If the half cell is a component of a potentiometric sensor, then the measurement circuit is used for detecting a potential difference between the half cell and another half cell, or more specifically, between the potential sensing element of the half cell and a potential sensing element of another half cell. If the half cell is a component of an amperometric sensor, which has a working electrode and a counter electrode in addition to the half cell acting as a reference electrode, the measurement circuit is used to preset a nominal voltage or a nominal voltage curve between the working electrode and the reference electrode and to detect the current flowing between the working electrode and the counter electrode.

In an advantageous embodiment, the total volume of the gas bubbles is between 3 and 50%, preferably between 3 and 25%, more preferably 5% of the total volume occupied by the electrolyte and the gas bubbles entrapped therein.

The housing may comprise an electrochemical junction, in particular a liquid junction, which is arranged in a housing wall and over which the electrolyte is in electrolytic contact with a medium which is arranged outside of the housing.

The electrochemical junction may comprise a diaphragm, which is arranged in an opening in the housing wall and has a contact surface contacting the electrolyte. In an advantageous embodiment, a plurality of gas bubbles, in particular all gas bubbles, have a mean diameter which is smaller than half of a minimum diameter of the contact surface line passing through a centroid (geometric center) of the contact surface.

In this way, a gas bubble that is present directly at the contact surface of the diaphragm with the electrolyte is prevented from interrupting the electrolytic contact between the electrolyte and the medium that is arranged outside the housing.

In the event that the junction is configured as an opening that passes through the entire wall of the housing or as a porous solid body arranged in the wall, in particular in the form of a circular disk or a pin or plug, the following applies advantageously to the minimum diameter D of the contact surface extending through the centroid of the contact surface of the diaphragm with the reference electrolyte

$$D \geq 2 \sqrt[3]{\frac{6 V}{π}} ,$$

where V is the average volume of the gas bubbles. More preferably the following applies to the minimum diameter D of the contact surface that extends through the centroid of the contact surface of the diaphragm with the reference electrolyte

$$D \geq 4 \sqrt[3]{\frac{6 V}{π}} .$$

In the event that the electrochemical junction is formed as a gap, arranged in an end wall of the housing, or as a ring made of porous solid, e.g. Teflon, arranged in the end wall of the housing, so that the contact surface between the transition area and the is electrolyte also has an annular shape, the following applies advantageously for the difference between the outer diameter Dₐ and the inner diameter Dᵢ of the gap or ring:

$${D}_{a} - {D}_{i} \geq 4 \sqrt[3]{\frac{6 V}{π}} .$$

More preferably the following applies to this case,

$${D}_{a} - {D}_{i} \geq 8 \sqrt[3]{\frac{6 V}{π}} ,$$

where V is again the average volume of the gas bubbles.

The electrolyte may comprise a halide with a preset concentration and/or a pH buffer system. A pH buffer system comprises at least one weak acid and its conjugate base or a weak base and its conjugate acid, and is used to stabilize the pH value of the electrolyte.

An electrolyte comprising such a pH buffer system is also referred to here and hereinafter as buffer solution or as a buffer in short.

The electrolyte may be a bridge electrolyte in contact with another electrolyte, in particular a reference electrolyte that comprises a halide at a preset concentration, particularly if the half cell is a reference half cell of a potentiometric sensor.

The housing may be sealed by means of an adhesive layer or sealing layer, wherein the volume occupied by the electrolyte directly adjoins the adhesive layer.

The invention also relates to an electrochemical sensor, comprising a half cell according to one of the embodiments described above. Besides the half cell, the sensor may comprise at least one additional half cell and a measurement circuit that is electrically conductively connected with the potential sensing element of the half cell and a potential sensing element of the additional half cell. As already mentioned above, the measurement circuit may be used for detecting a potential difference between the half cells or for setting a nominal voltage between the half cell and an additional half cell or electrode, depending on the sensor type, and for detecting a current flowing between the additional half cell or electrode and a counter electrode. The measurement circuit may also be configured to generate a measuring signal representing the measured variable from the recorded measured variable, e.g. the is potential difference or the amperage of the current flowing between the additional half cell and the counter electrode, and if appropriate, to further process, for example to digitize the measuring signal and output the same or a processed measuring signal to a higher-level unit. The higher-level unit may be a measuring transducer, a computer, a programmable logic controller or a process control computer.

The inventive method for producing a half cell comprises the steps of:

provision of a housing;

introduction of a preset amount of an electrolyte solution into the housing, which comprises a solidifying agent, in particular one or more polymerizable monomers and/or a cross-linkable pre-polymer; and

solidification of the electrolyte solution contained in the housing, in particular by heating or irradiation of the electrolyte solution up to the formation of a solidified electrolyte from the electrolyte solution,

wherein gas bubbles are introduced during the solidification of the electrolyte solution into the volume of the housing occupied by the electrolyte solution, which remain as immobilized gas bubbles in the solidified electrolyte.

The electrolyte solution may comprise a cross-linkable pre-polymer as a solidifying agent, and solidification of the electrolyte solution may occur by means of the cross-linking of the pre-polymer, wherein said solidification includes heating or irradiation of the electrolyte solution, and adding a cross-linking agent or photo-sensitizer to the electrolyte solution.

The electrolyte solution may comprise one or more polymerizable monomers as the solidifying agent, and the solidification of the electrolyte solution may occur by means of polymerization, wherein said solidification comprises heating or irradiation of the electrolyte solution and/or adding an initiator to the electrolyte solution.

The irradiation can be done with UV radiation, microwave radiation or ultrasonic waves in all the cases mentioned.

A substance, which undergoes a chemical reaction with at least one other substance contained in the electrolyte solution at the conditions prevailing during solidification to form a gaseous reaction product, or which decomposes to form a gas at the conditions prevailing during solidification, may be used as the gas-forming agent.

The gas-forming agent may be, e.g., an azo compound, a peroxide or a substance which is capable of releasing carbon dioxide, such as carbonate, hydrogen carbonate, or a carboxylic acid, and wherein the electrolyte solution is heated to solidify at a preset temperature, and wherein the azo initiator or peroxide is thermally decomposed at the preset temperature to form a gas.

In these embodiments of the method, the reaction, which leads to the release of the gas, is coupled to the solidification of the electrolyte by polymerization or cross-linking. The size distribution of gas bubbles can be adjusted by influencing the reaction kinetics, e.g. by adjusting the reactant concentration or temperature.

Seed crystals, in particular particles having sharp edges, hydrophobic particles, or surface-active substances, e.g. surfactants, can be added to the electrolyte solution, in particular during solidification of the electrolyte, for the formation of gas bubbles.

In an alternative embodiment of the method, the gas bubbles can be produced by blowing gas into the electrolyte solution, in particular during the solidification of the electrolyte, or by expelling gas, such as carbon dioxide (CO₂), from a gas-saturated solution by heating.

In another alternative embodiment of the method, the gas bubbles may be introduced by providing the electrolyte solution with gas-filled hollow bodies, whose wall dissolves in the electrolyte solution, preferably during solidification, e.g. at an elevated temperature, so that gas bubbles remain in the solidifying electrolyte.

Before the solidification of the electrolyte solution, at least a portion of a potential sensing element or a protective tube surrounding a potential sensing element may be introduced into the housing.

An adhesive layer, which encloses the electrolyte in the housing or a sealing layer, through which an electrically conductive connection of the potential sensing element with an electrical terminal pad arranged outside of the housing or the protective tube surrounding the potential sensing element is guided, is applied on the electrolyte after its solidification.

The invention is described in detail below with reference to the exemplary embodiments illustrated in the figures. The drawings depict:

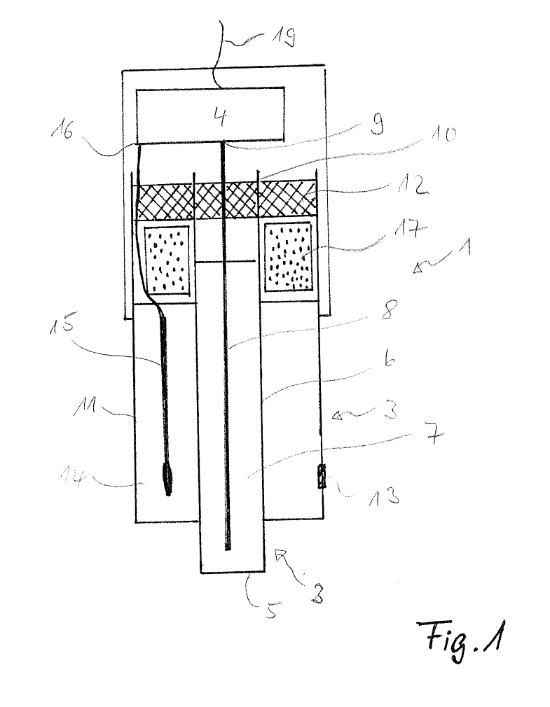

FIG. 1 is a schematic drawing of a potentiometric sensor according to the prior art;

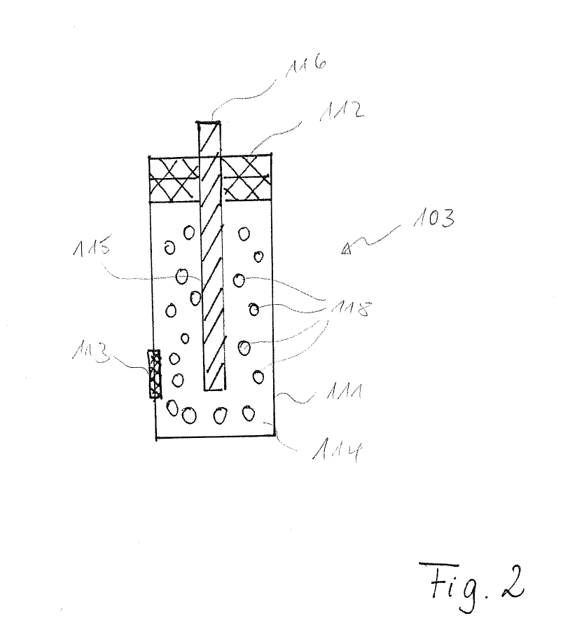

FIG. 2 is a schematic representation of an electrochemical half cell according to the invention;

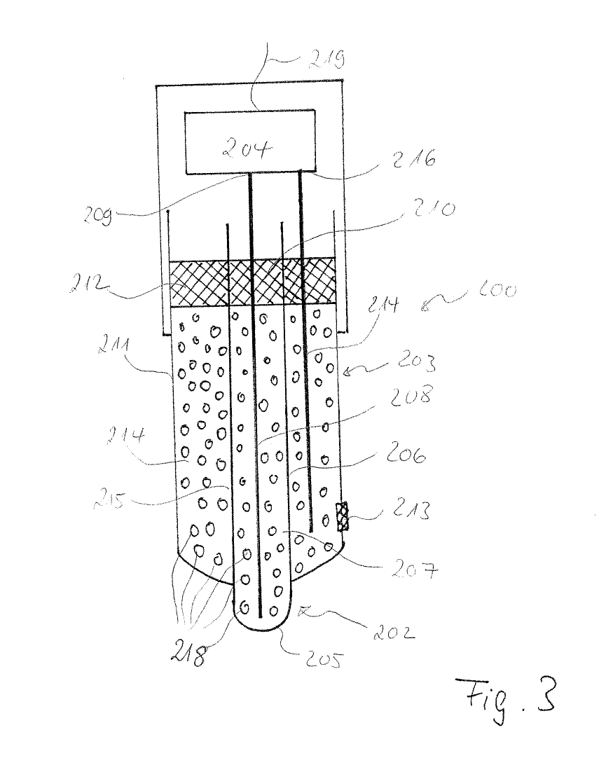

FIG. 3 is a schematic representation of a potentiometric pH sensor with a reference half cell having a solidified reference electrolyte with entrapped gas bubbles;

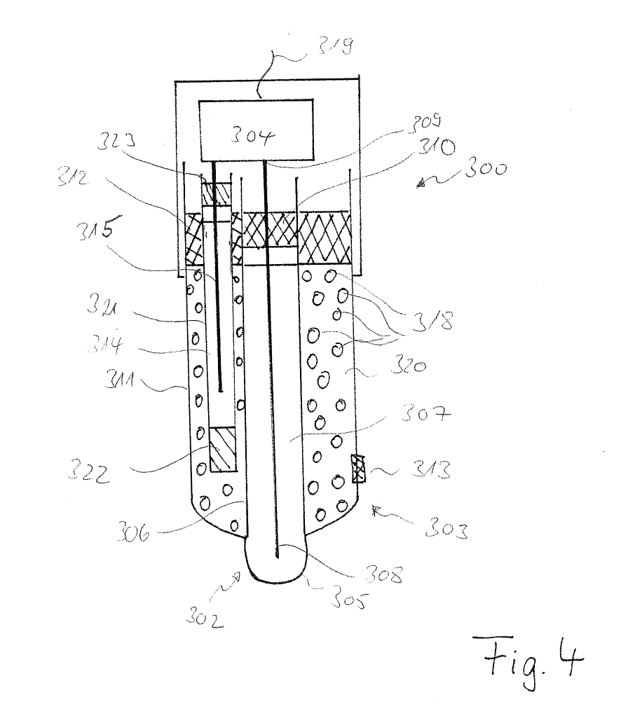

FIG. 4 is a schematic representation of a potentiometric sensor with a reference half cell, which has a solidified bridge electrolyte with entrapped gas bubbles.

FIG. 1 is a schematic representation of a potentiometric sensor 1 according to the prior art in longitudinal section. The sensor 1 comprises a measuring half cell 2 and a reference half cell 3 and a measurement circuit 4, which is configured to detect a potential difference between the measuring half cell 2 and the reference half cell 3. The sensor 1 is configured as a rod-shaped measuring probe whose front end region is intended to be immersed in a measuring medium.

The measuring half cell 2 has an analyte-sensitive membrane 5, which is an ion-selective membrane in this example. This closes an inner tube 6 of the sensor 1 at its front end. An inner electrolyte 7 is contained in the housing formed by the inner tube 6. In the present example, the inner electrolyte 7 is an aqueous solution containing a preset concentration of the analyte, whose concentration is to be monitored in the measuring medium by means of the sensor 1. In the inner electrolyte 7, a potential sensing element 8 is immersed, which is connected to the measurement circuit 4 via a terminal pad 9 outside of the housing of the measuring half cell 2 formed by the inner tube 6. At its rear end facing away from the analyte-sensitive membrane 5, the inner tube 6 is sealed by an adhesive bonding 10.

The reference half cell 3 comprises an annular housing formed between the inner tube 6 and an outer tube 11 concentrically extending around the inner tube 6. This is also closed at its rear end by an adhesive bonding 12. In the outer housing wall, i.e. in the outer tube 11, a diaphragm 13 used as an electrochemical junction is arranged. This may be formed, e.g., by a porous solid. The housing of the reference half cell 3 includes a reference electrolyte 14 which is immobilized by adding a polymer and has a specified halide concentration. The polymer has such a high degree of cross-linking that the reference electrolyte 14 is solidified, thus rendering it incapable of flowing. The reference electrolyte 14 is contacted by a potential sensing element 15 that is used as a reference element of the reference half cell at the same time. In the present example, the potential sensing element 15 is made of a silver wire having a silver chloride layer in its front end region. Its rear end is led out of the housing through the adhesive bonding 12 and connected to the measurement circuit 4 via a terminal pad 16.

In order to measure an analyte concentration in a measuring medium, the front end region of the sensor 1 is immersed in the measuring medium to the extent that both the membrane 5 and the diaphragm 13 are in contact with the measuring medium. The measurement circuit 4 is configured to detect a potential difference between the potential sensing element 8 of the measuring half cell 2 and the potential sensing element 15 of the reference half cell 3 and to output a dependent measuring signal to a higher-level unit via the interface 19. The potential difference detectable between the potential sensing elements 8 and 15 depends on the analyte concentration in the measuring medium, so that the measuring signal output from the measurement circuit 4 represents the analyte concentration or a measured variable that is a function of the analyte concentration.

As mentioned above, changes in volume of the reference electrolyte 14 can be compensated by means of compensators 17, which are arranged in a space formed in the housing of the reference half cell 3 above the volume occupied by the reference electrolyte 14. In the present example, a single annular compensator 17 made of an elastic, closed-pore material, e.g. neoprene, or a closed-pore silicone foam is provided. Changes in volume of the reference electrolyte 14 associated with fluctuations in temperature are offset by corresponding changes in volume of the compensator 17.

However, the compensation of changes in the volume of the reference electrolyte 14 using compensators 17 designed as solid bodies has several drawbacks: On the one hand, there may be an electrostatic charge during operation on the surface of the compensator 17 made of neoprene or other plastic material, thus affecting the quality of measurement. On the other hand, the introduction of one or more compensators 17 into the housing is difficult to automate and furthermore, there is a risk of contaminating the housing, in particular the areas intended for the adhesive bonding 12, when introducing the compensators, which in turn may lead to insufficient seal-tightness of the adhesive bonding 12. Finally, the arrangement of the compensator above the space of the housing occupied by the reference electrolyte is also not optimal during operation of the sensor 1, in particular in case of sensors with a long shaft, so that the reference electrolyte 14 may tear off during operation.

In FIG. 2, a half cell 103 according to the invention is shown, which avoids these problems or at least significantly reduces them. The half cell 103 includes a housing 111 made of an electrically insulating material, such as glass, in which an electrolyte 114 that is solidified by a cross-linked polymer is included. In this example, the half cell 103 is designed as a reference half cell, which can be used, e.g., in a measuring arrangement operating according to a potentiometric or an amperometric measuring principle. The reference half cell 103 is configured as a silver/silver chloride electrode. It goes without saying that the reference half cell can also be implemented in the form of an additional reference electrode of the second type in an analogous manner. The reference electrolyte 114 includes a high concentration of a chloride salt, which is specifically a 3 molar potassium chloride solution in the present case. The is reference electrolyte 114 is in electrolytic contact with a measuring medium, arranged outside the housing, via a diaphragm 113, which is arranged in the wall of the housing 111 and may be made of, e.g., an open-pore ceramic body. While measuring an analyte concentration in the measuring medium, the front end region of the housing is immersed in this medium at least to the extent that the diaphragm 113 is completely immersed in the measuring medium.

In the reference electrolyte 114, a potential sensing element 115 is immersed, which is designed in the present example as a silver wire having a silver chloride layer at least in its end region.

The potential sensing element 115 is led out of the housing through an adhesive layer 112, closing the rear end of the housing, to a terminal pad 116 at which a measurement circuit may be in electrical contact with the potential sensing element.

The reference electrolyte 114 comprises a polymer having such a high degree of cross-linking that the reference electrolyte is solidified, in particular cut-resistant, thus being completely immobilized. In the present example, the polymer can be made of the monomers acrylamide and bis-acrylamide. A plurality of gas bubbles 118 are embedded in the reference electrolyte 114. These gas bubbles 118 are immobilized within the solidified reference electrolyte 114 and are mostly uniformly distributed, so that they cannot escape the reference electrolyte 114, and cannot flow into one another. The solidified reference electrolyte 114 containing the gas bubbles 118 can thus be viewed as a solid foam. The gas bubbles 118 are used as compensation volumes for changes in volume of the solid component of the reference electrolyte 114 occurring due to temperature variations. The adhesive layer 112 is applied directly on the solidified reference electrolyte 114. No additional compensators are required within the housing as the voids 118 contained in the reference electrolyte 114 are compressible. This also eliminates the disadvantages of the prior art described with reference to FIG. 1.

The half cell 103 may be part of a potentiometric measuring arrangement that also comprises a measuring half cell and a measurement circuit. The measurement circuit of the potentiometric measuring arrangement is designed to detect the potential difference between the measuring half cell and the reference half cell. The measuring half cell may comprise, e.g., an ion-selective membrane or a pH-sensitive glass membrane at which a potential that is a function of a concentration of the analyte in the measuring medium sets in upon contact with the measuring medium. The measuring half cell may be arranged in a housing that is not associated with the housing of the half cell 103, but it is also possible that the half cell 103 is part of a single-rod measuring cell, which has the same design as the sensor shown in FIG. 1.

In another embodiment as a reference electrode, the half cell 103 may be a component of an amperometric measuring arrangement, which also comprises a working electrode and a counter electrode and a measurement circuit that is electrically conductively connected to the reference electrode, the working electrode and the counter electrode. The reference electrode, the working electrode and the counter electrode are brought into contact with the measuring medium for measurement. In the amperometric measuring arrangement, the measurement circuit may comprise a potentiostatic control circuit, which is configured to specify a nominal voltage between the working electrode and the non-current-carrying reference electrode and to detect the amperage of the current flowing through the measuring medium while setting the nominal voltage and to generate and output an associated measuring signal.

The half cell shown in FIG. 2 can be produced by introducing into the housing 111 a 3 molar solution of KCI with added polymerizable monomers, such as acrylamide and bis-acrylamide, as well as an initiator for the polymerization and a gas-forming agent. A peroxide can be used as an initiator, for example. The gas-forming agent may be an azo compound or a compound that is suitable to release carbon dioxide, such as carbonate, hydrogen carbonate or a carboxylic acid. The solution contained in the housing is heated, so that the polymerization reaction is used for the formation of polyacrylamide. Simultaneously, the gas-forming agent is also decomposed at the temperature prevailing during polymerization to form gas. If the gas-forming agent is an azo compound, nitrogen is produced during its decomposition. If the gas-forming agent is a peroxide, oxygen is accordingly produced during its decomposition. Seed crystals, such as micro-particles or nano-particles or surface-active substances, such as surfactants, can be added to the solution for the formation of gas bubbles. During the polymerization reaction, gas bubbles, which remain immobilized in the electrolyte to form a solidified electrolyte upon completion of the polymerization are formed within the electrolyte solution with ever-increasing viscosity. The result is therefore a solid foam, which comprises a plurality of gas bubbles with the solid walls formed by the solidified electrolyte.

In an alternative production method, an electrolyte solution, which contains 3 mol/L potassium chloride, a cross-linkable pre-polymer, e.g. a DADMAC-diallyl copolymer (DADMAC is an abbreviation of diallyl dimethyl ammonium chloride), a cross-linking agent, e.g. diglycidyl ether, and a gas-forming agent, e.g. a peroxide, is introduced into the housing. While heating the electrolyte solution, the cross-linking of the polymer sets in, while at the same time the gas-forming agent is decomposed, forming gas bubbles. Seed crystals may also be added for formation of gas bubbles as in the first example. Once cross-linking is completed, the gas bubbles remain in the solidified electrolyte as immobilized voids.

In another alternative production method, the gas bubbles are introduced into the electrolyte solution by blowing in gas, e.g. nitrogen, during solidification. In this case, the gas-forming agent can be dispensed with in the electrolyte solution.

The number and size distribution of gas bubbles in the so-formed solid foam can be adjusted by the concentration of the reactants and the temperature control of the solidification reaction (polymerization or cross-linking). During the formation of gas bubbles by blowing a gas into the electrolyte solution, the number and size distribution of the gas bubbles can be adjusted by the blowing pressure, the temperature and the duration of blowing. In order to safely avoid any interruption of the electrical contact between the reference element 115 and a measuring medium present outside the housing by a gas bubble adjoining the diaphragm 113, the size of the gas bubbles and the diameter of the contact surface of the diaphragm 113 to the reference electrolyte 114 are advantageously adapted such that the maximum diameter of each gas bubble is much smaller than the diameter of the contact surface of the diaphragm 113 with the reference electrolyte 114.

Assuming that the gas bubbles are essentially spherical, the following applies to the diameter d of a gas bubble

$$d = \sqrt[3]{\frac{6 V}{π}} ,$$

where V is the average volume of the gas bubbles. Preferably the following applies to the minimum diameter D of the contact surface that extends through the centroid of the contact surface of the diaphragm with the reference electrolyte

$$D \geq 2 \sqrt[3]{\frac{6 V}{π}} .$$

This relationship is also true if the gas bubbles differ from the spherical shape. Afterwards, the adhesive layer 112 can directly be applied on the solidified electrolyte.

Below are examples of some test results to demonstrate which parameters have an impact on the number and size of gas bubbles in different electrolytes.

Table 1 shows test results for the generation of gas bubbles in the electrolyte solutions of differing composition, to which different quantities of the gas-forming agent, a peroxide in this case, were added, thus forming gas bubbles which remained in the solidified electrolyte during the solidification of the electrolyte solutions by polymerizing or cross-linking at a temperature of about 55° C. The proportions of polymer, cross-linking agent and gas-forming agent are expressed as % by weight in each case, based on the total weight of the electrolyte. The proportion of DAA in examples 5 to 8 is expressed as mol. %, based on the total weight of polymer.

After completion of the polymerization or cross-linking, the strength of the electrolyte, and the average size and number of the trapped gas bubbles were examined. The average size of the gas bubbles was divided into four categories: “Very small” (average diameter of gas bubbles <0.5 mm), “small” (average diameter of gas to bubbles between 0.5 and 1 mm), “medium” (average diameter of gas bubbles between 1 and 2 mm) and “large” (average diameter of gas bubbles >2 mm). By visual inspection of the samples, the amount of gas bubbles formed was qualitatively classified into the four categories “little,” “medium,” “high” and “very high.”

TABLE 1

| | | Proportion | Proportion | Proportion of | | | | |
|---|---|---|---|---|---|---|---|---|
| | | of | of cross- | gas-forming | | Number | | |
| | | polymer | linkers | agents | Bubble | of | | |
| No. | Polymer additive | [% (w/w)] | [% (w/w)] | [% (w/w)] | size | bubbles | Distribution | Strength |
| 1 | PAA/BAA | 8 | 0.6 | 0.26 | Cracks | Cracks | homogeneous | solid |
| 2 | PAA/BAA | 8 | 0.6 | 0.53 | Cracks | Cracks | homogeneous | solid |
| 3 | PAA/BAA | 8 | 0.025 | 0.26 | large | many | homogeneous | solid |
| 4 | PAA/BAA | 8 | 0.025 | 0.53 | large | many | homogeneous | solid |
| 5 | DADMAC/DAA | 5.5 | 1.22 | 0.26 | large-very | many | inhomogeneous | solid |
| | (DAA 4 mol. %) | | | | small | | | |
| 6 | DADMAC/AMPS/ | 13.3 | 1.22 | 0.26 | large- | many | inhomogeneous | solid |
| | DAA | | | | small | | | |
| | (DAA 2 mol. %) | | | | | | | |
| 7 | DADMAC/AMPS/ | 7 | 1.22 | 0.26 | large- | less | inhomogeneous | soft |
| | DAA | | | | medium | | | |
| | (DAA 2 mol. %) | | | | | | | |
| 8 | DADMAC/AMPS/ | 6 | 1.22 | 0.26 | medium | less | inhomogeneous | fluid |
| | DAA | | | | | | | |
| | (DAA 2 mol. %) | | | | | | | |

The abbreviations have the following meanings:

PAA: Polyacrylamide

BAA: Bis-acrylamide (N, N′-methylene diacrylamide)

DADMAC: Diallyl dimethyl ammonium chloride

DAA: Diallylamine

AMPS: 2-acrylamido-2-methyl-1-propane sulfonic acid.

Examples 1 and 2, in which cracking was observed, are used as comparative examples.

Table 2 shows test results, in which the electrolyte solution was added as nucleating agent or as seed crystals to assist the formation of bubbles of high-purity, ultra-fine, agglomerate-free aluminum oxide powder (TM-DAR), available from Taimei Chemicals Co. Moreover, the solidification of the electrolyte solution containing a polymer additive, a cross-linking agent and a gas-forming agent was carried out analogously to the experiments shown in Table 1, in particular the solidification and gas formation was also carried out at about 55° C.

TABLE 2

| | | | | Proportion | | | | | |
|---|---|---|---|---|---|---|---|---|---|
| | | Proportion | Proportion | of gas- | | | | | |
| | | of | of cross- | forming | | | Number | | |
| | Polymer | polymer | linkers | agents | TM-DAR | Bubble | of | | |
| No. | additive | [% (w/w)] | [% (w/w)] | [% (w/w)] | [% (w/w)] | size | bubbles | Distribution | Strength |
| 9 | PAA/BAA | 3.75 | 0.025 | 0.26 | 0.88 | small | very | homogeneous | soft |
| | | | | | | | much | | |
| 10 | PAA/BAA | 5.62 | 0.025 | 0.26 | 0.44 | small | many | homogeneous | solid |
| 11 | PAA/BAA | 7.12 | 0.025 | 0.26 | 0.09 | medium | many | homogeneous | solid |
| 12 | PAA/BAA | 7.31 | 0.025 | 0.26 | 0.04 | medium | many | homogeneous | solid |
| 13 | PAA/BAA | 7.46 | 0.025 | 0.26 | 0.01 | medium | many | homogeneous | solid |
| 14 | PAA/BAA | 3.75 | 0.025 | 0.53 | 0.88 | small | very | homogeneous | soft |
| | | | | | | | much | | |
| 15 | PAA/BAA | 5.62 | 0.025 | 0.53 | 0.44 | medium | many | homogeneous | solid |
| 16 | PAA/BAA | 7.12 | 0.025 | 0.53 | 0.09 | medium | many | homogeneous | solid |
| 17 | PAA/BAA | 7.31 | 0.025 | 0.53 | 0.04 | medium | many | homogeneous | solid |
| 18 | PAA/BAA | 7.46 | 0.025 | 0.53 | 0.01 | medium | many | homogeneous | solid |
| 19 | DADMAC/ | 2.75 | 0.54 | 0.26 | 0.88 | medium | less | homogeneous | soft |
| | DAA | | | | | | | | |
| | DAA 4 mol. % | | | | | | | | |
| 20 | DADMAC/ | 4.13 | 0.81 | 0.26 | 0.44 | large- | less | homogeneous | solid |
| | DAA | | | | | medium | | | |
| | DAA 4 mol. % | | | | | | | | |
| 21 | DADMAC/ | 5.23 | 1.03 | 0.26 | 0.09 | large- | less | inhomogeneous | solid |
| | DAA | | | | | medium | | | |
| | DAA 4 mol. % | | | | | | | | |
| 22 | DADMAC/ | 9.98 | 0.81 | 0.26 | 0.44 | large- | less | inhomogeneous | soft |
| | AMPS/DAA | | | | | medium | | | |
| | DAA 2 mol. % | | | | | | | | |
| 23 | DADMAC/ | 12.64 | 1.03 | 0.26 | 0.09 | medium | medium | inhomogeneous | solid |
| | AMPS/DAA | | | | | | | | |
| | DAA 2 mol. % | | | | | | | | |

Table 3 shows test results, in which surfactants were additionally added to the electrolyte solution as nucleating agent or to support the bubble formation. Sodium hexadecyl sulfate (NHDS) was used as the surfactant in some experiments, while sodium dodecyl sulfate (SDS) was used in other experiments. Moreover, the solidification of the electrolyte solution containing a polymer additive, a cross-linking agent and a gas-forming agent was carried out analogously to the experiments shown in Table 1, but the solidification and gas formation was carried out at about 80° C.

TABLE 3

| | | | Proportion | | | | | | |
|---|---|---|---|---|---|---|---|---|---|
| | | Proportion | of gas- | Proportion | Proportion | | | | |
| | | of | forming | of | of | | Number | | |
| | Polymer | polymer | agents | TM-DAR | surfactant | Bubble | of | | |
| No. | additive | [% (w/w)] | [% (w/w)] | [% (w/w)] | [% (w/w)] | size | bubbles | Distribution | Strength |
| 24 | PAA/BAA | 7.5 | 0.04 | | | medium | many | homogeneous | solid |
| | (BAA | | | | | | | | |
| | 0.025 mol. %) | | | | | | | | |
| 25 | PAA/BAA | 7.5 | 0.04 | | 0.03 NHDS | very | very | homogeneous | solid |
| | (BAA | | | | | small | much | | |
| | 0.025 mol. %) | | | | | | | | |
| 26 | PAA/BAA | 5.62 | 0.04 | 0.0033 | | small | many | homogeneous | solid |
| | (BAA | | | | | | | | |
| | 0.025 mol. %) | | | | | | | | |
| 27 | PAA/BAA | 5.62 | 0.04 | 0.0033 | 0.03 NHDS | very | very | homogeneous | solid |
| | (BAA | | | | | small | much | | |
| | 0.025 mol. %) | | | | | | | | |
| 28 | PAA/BAA | 7.5 | 0.04 | | 0.43 SDS | medium | medium | homogeneous | solid |
| | (BAA | | | | | | | | |
| | 0.025 mol. %) | | | | | | | | |
| 29 | PAA/BAA | 5.62 | 0.04 | 0.0033 | 0.43 SDS | small | many | homogeneous | solid |
| | (BAA | | | | | | | | |
| | 0.025 mol. %) | | | | | | | | |

FIG. 3 schematically shows a potentiometric pH sensor 200 in longitudinal sectional view. The sensor 200 has a measuring half cell 202 and a reference half cell 203 and a measurement circuit 204, which is configured to detect a potential difference between to the measuring half cell 202 and the reference half cell 203. The pH sensor 200 is configured as a single-rod measuring cell as the sensor 1 described with reference to FIG. 1 of the prior art.

The measuring half cell 202 comprises a pH-sensitive glass membrane 205, which is closes an inner tube 206 of the pH sensor 200 at its front end. An inner electrolyte 207 is contained in the housing formed by the inner tube 206. In this example, the inner electrolyte 207 is a solid foam which is formed from a polymer-solidified buffer solution and gas bubbles 218 enclosed therein. The potential sensing element 208 is in contact with the inner electrolyte 207 and is connected to the measurement circuit 204 via a terminal pad 209 outside of the housing of the measuring half cell 202 formed by the inner tube 206. At its rear end facing away from the glass membrane 205, the inner tube 206 is sealed liquid-tight by an adhesive layer 210 directly adjoining the inner electrolyte 207.

The housing of the reference half cell 203 is formed by the inner tube 206 and the outer tube 211 extending concentrically around the inner tube 206. In the outer housing wall, i.e. in the outer tube 211, a diaphragm 213 used as an electrochemical transition area is arranged. This may be formed, e.g., by an open-pore solid body made of ceramic or plastic. The housing of the reference half cell 203 includes a reference electrolyte 214 which is immobilized by adding a polymer and has a specified halide concentration, in particular 3 mol/L. The polymer has such a high degree of cross-linking that the reference electrolyte is not fluid, but is, in particular cut-resistant. A plurality of gas bubbles 218 are trapped in the solidified reference electrolyte 214 as in the inner electrolyte 207 of the measuring half cell 202. The reference electrolyte 214 is contacted by a potential sensing element 215 that is used as a reference element of the reference half cell 203 at the same time. In the present example, the potential sensing element 215 is made of a silver wire having a silver chloride layer in its front end region. Its rear end is led out of the housing through the adhesive layer 212, which seals the housing of the reference half cell 203 at the rear and directly adjoins the reference electrolyte 214, and is connected to the measurement circuit 204 via a terminal pad 216.

The measurement circuit 204 is configured to detect a potential difference between the potential sensing element 208 of the measuring half cell 202 and the potential sensing element 215 of the reference half cell 203 and to output a dependent measuring signal to a higher-level unit via the interface 219.

The measuring half cell 202 with the inner electrolyte 207 and the reference half cell 203 with the reference electrolyte 214 can be produced analogously to the reference half cell 103 described with reference to the production illustrated in FIG. 2.

In a longitudinal sectional view, FIG. 4 schematically illustrates a potentiometric pH sensor 300, whose reference half cell 300 includes a bridge electrolyte 320.

The pH sensor 300 comprises a measuring half cell 302, which comprises an inner electrolyte 307 housed in an inner tube 306 that is sealed by the pH-sensitive glass membrane 305 at a front side. The inner electrolyte 307 is an aqueous buffer solution with no thickening additives in the present example. The back of the inner tube is closed by an adhesive bonding 310, wherein a gas-filled space is provided between the inner electrolyte 307 and the adhesive bonding 310 to compensate for thermal changes in the volume of the inner electrolyte 307. A potential sensing element 308, which can be configured, e.g., as a silver wire, is immersed in the inner electrolyte 307. The potential sensing element is guided through the adhesive bonding 310 to a terminal pad 309 outside the housing, with which the measurement circuit 304 is electrically conductively connected. Of course, the measuring half cell 302 could also be designed in the same way as the measuring half cell 202 of the sensor 200 shown in FIG. 3.

The reference half cell 303 of the pH sensor 300 comprises a housing, which is formed by an inner tube 306 and an outer tube 311 concentrically surrounding the inner tube 306 and within which a protective tube 321 is arranged. The front end of the protective tube 321 has a diaphragm 322, which is formed from an open-pore solid body, e.g. a glass drip, a porous ceramic or plastic. The protective tube 321 contains a liquid reference electrolyte 314, which contains chloride at a preset concentration, and in which a potential sensing element 315, e.g. a silver wire coated with silver chloride, is immersed. The reference electrolyte 314 may be thickened by a polymer, but is advantageously in a fluid state. At its end facing away from the diaphragm 322, the protective tube 321 is closed by an adhesive bonding 323. A gas space is provided between the adhesive bonding 323 and the reference electrolyte to compensate for thermally caused changes in the volume of the reference electrolyte 314. The potential sensing element 315 is passed through the adhesive bonding 323, and is electrically conductively connected to the measurement circuit 304 via the terminal pad 316. As in the exemplary embodiment described with reference to FIG. 3, the measurement circuit 304 is configured to detect a potential difference between the potential sensing element 315 of the reference half cell 303 and the potential sensing element 308 of the measuring half cell 302 and to output a dependent measuring signal to a higher-level unit via the interface 319.

The housing formed by the inner tube 306 and the outer tube 311 contains a bridge electrolyte 320, which is configured as a solid foam made of a polymer-solidified electrolyte, and gas bubbles 318 embedded therein, and surrounds the protective tube 321, so that the reference electrolyte 315 is in electrolytic contact with the bridge electrolyte 320 across the diaphragm 322. In the wall of the outer tube 311, another diaphragm 313 is arranged, which may also be formed from an open-pore solid body, and via which the bridge electrolyte 320 is in electrolytic contact with a measuring medium outside of the housing. The housing of the reference half cell 303 is closed by an adhesive layer 312 directly adjoining the bridge electrolyte 320. The adhesive layer 312 need not directly be adjoining the bridge electrolyte 320, but it is also possible to leave a gas space between the bridge electrolyte and the adhesive layer.

The bridge electrolyte 320 may be produced in the same manner as the reference electrolyte of the reference half cell shown in FIG. 2, by introducing a monomer-containing electrolyte solution and an initiator for polymerization of the monomers as well as a gas-forming agent into the housing, by carrying out the polymerization until solidification of the electrolyte solution, wherein the gas-forming agent is decomposed during polymerization to form a gas, thus forming gas bubbles during solidification of the electrolyte that remain trapped in the electrolyte after its solidification, so as to provide a solid foam.

In an alternative production process, an electrolyte solution containing a cross-linkable pre-polymer and a cross-linking agent, as well as a gas-forming agent may be introduced into the housing, wherein the gas-forming agent is decomposed during the cross-linking of the pre-polymer until solidification of the electrolyte solution, releasing a gas, thus forming gas bubbles during solidification of the electrolyte solution that remain trapped in the electrolyte after its solidification.

The size of the gas bubbles 318 and the sizes of the diaphragm 313 and of the diaphragm 322 are ideally coordinated such that the maximum diameter of each gas bubble is much smaller than a minimum diameter D₁, extending through the centroid of the contact surface of the diaphragm 313 with the bridge electrolyte 320, and than a minimum diameter D₂, extending through the centroid of the contact surface of the diaphragm 322 with the bridge electrolyte 320.

Advantageously the following also applies to the diameter D₁

$${D}_{1} \geq 2 \sqrt[3]{\frac{6 V}{π}} ,$$

where V is the average volume of the gas bubbles, and accordingly to D₂

$${D}_{2} \geq 2 \sqrt[3]{\frac{6 V}{π}} .$$

1. Electrochemical half cell comprising:
a housing;
a potential sensing element, which is at least partially arranged within the housing and is electrically conductively connected to an electrical terminal arranged outside the housing; and
an electrolyte that is solidified and arranged within the housing, characterized in that a plurality of gas bubbles which are in particular uniformly distributed within the volume occupied by the electrolyte, are trapped in the electrolyte.

2. Half cell according to claim 1, wherein the total volume of the gas bubbles is between 3 and 50%, in particular between 3 and 25%, of the total volume occupied by the electrolyte and the gas bubbles entrapped therein.

3. Half cell according to claim 1 wherein the housing comprises an electrochemical junction, in particular a liquid junction, which is arranged in a housing wall and via which the electrolyte is in electrolytic contact with a medium which is arranged outside of the housing.

4. Half cell according to claim 3, wherein the electrochemical junction comprises a diaphragm, which is arranged in an opening in the housing wall and has a contact surface contacting the electrolyte, and wherein a plurality of gas bubbles, in particular all gas bubbles, have a mean diameter, which is smaller than half of a minimum diameter of the contact surface line passing through a centroid (geometric center) of the contact surface.

5. Half cell according to claim 1, wherein the electrolyte comprises a preset halide concentration and/or a pH buffer system.

6. Half cell according to claim 1, wherein the electrolyte is a bridge electrolyte in electrolytic contact with another electrolyte, in particular with a reference electrolyte comprising a preset halide concentration.

7. Half cell according to claim 1, wherein the housing is sealed by means of an adhesive layer, wherein the volume occupied by the electrolyte directly adjoins the adhesive layer.

8. An electrochemical sensor comprising a half cell according to claim 1.

9. Method for producing a half cell, comprising the steps of:
providing of a housing;
introducing of a preset amount of an electrolyte solution into the housing, which solution comprises a solidifying agent, in particular one or more polymerizable monomers and/or a cross-linkable pre-polymer; and
solidifying of the electrolyte solution contained in the housing, in particular by heating or irradiating of the electrolyte solution up to the formation of a solidified electrolyte from the electrolyte solution, characterized in that gas bubbles are introduced during the solidifying of the electrolyte solution into the volume of the housing occupied by the electrolyte solution, which remain as immobilized gas bubbles in the solidified electrolyte.

10. Method according to claim 9, wherein the electrolyte solution comprises a cross-linkable pre-polymer as a solidifying agent, and the solidifying of the electrolyte solution occurs by means of the cross-linking of the pre-polymer, wherein said solidifying includes heating or irradiating of the electrolyte solution, and adding a cross-linking agent or photosensitizer to the electrolyte solution.

11. Method according to claim 9, wherein the electrolyte solution comprises one or more polymerizable monomers as the solidifying agent, and the solidifying of the electrolyte solution occurs by means of polymerization, wherein said solidifiying comprises heating or irradiating of the electrolyte solution and/or adding an initiator to the electrolyte solution.

12. Method according to claim 9, wherein a substance, which undergoes a chemical reaction with at least one other substance contained in the electrolyte solution at the conditions prevailing during solidifying to form a gaseous reaction product, or which decomposes to form a gas at the conditions prevailing during solidifying, is used as the gas-forming agent,

13. Method according to claim 9, wherein the gas-forming agent is an azo compound, a peroxide or a substance which is capable of releasing carbon dioxide, such as carbonate, hydrogen carbonate, or a carboxylic acid, and wherein the electrolyte solution is heated to a preset temperature for solidifying, and wherein the azo initiator or peroxide is thermally decomposed at the preset temperature to form a gas.

14. Method according to claim 9, wherein seed crystals for the formation of gas bubbles, in particular particles having sharp edgesor hydrophobic particles ore or surface-active substances, are added to the electrolyte solution, in particular during the solidifying.

15. Method according to claim 9, wherein gas is blown into the electrolyte solution, in particular during solidification, or gas, such as carbon dioxide, is expelled from the gas-saturated electrolyte solution by heating.

16. Method according to claim 9, further comprising the step of:
introducing before the solidifying of the electrolyte solution at least a portion of a potential sensing element or a protective tube surrounding a potential sensing potential sensing element into the housing.

17. Method according to claim 16, wherein, after solidifying of the electrolyte to form a solidified electrolyte, an adhesive layer, which encloses the electrolyte in the housing and through which an electrically conductive connection of the potential sensing element with an electrical terminal arranged outside of the housing or the protective tube surrounding the potential sensing element is guided, is applied directly on the solidified electrolyte.
